(19) United States
(12) Patent Application Publication
(10) Pub. No.: US 2014/0056126 A1
(43) Pub. Date: Feb. 27, 2014

(54) METHOD AND SYSTEM FOR PROVIDING FAULT ISOLATION FOR A SERVICE PATH IN AN ETHERNET-BASED NETWORK

(71) Applicants: Michael U. BENCHECK, Richardson, TX (US); Matthew William Turlington, Richardson, TX (US); Scott R. Kotrla, Wylie, TX (US); Vincent A. Alesi, Yorktown Heights, NY (US); Christopher Nicholas DelRegno, Rowlett, TX (US)

(72) Inventors: Michael U. BENCHECK, Richardson, TX (US); Matthew William Turlington, Richardson, TX (US); Scott R. Kotrla, Wylie, TX (US); Vincent A. Alesi, Yorktown Heights, NY (US); Christopher Nicholas DelRegno, Rowlett, TX (US)

(73) Assignee: Verizon Patent and Licensing Inc., Basking Ridge, NJ (US)

(21) Appl. No.: 13/594,956

(22) Filed: Aug. 27, 2012

(51) Int. Cl. H04L 12/26; H04L 29/14

(52) U.S. Cl. 370/228; 370/242

(57) ABSTRACT

An approach for providing fault isolation for a service path in an Ethernet-based network is described. A service path within an Ethernet-based network and associated with a plurality of management levels is determined. A plurality of management points that are along the service path and that correspond to the management levels are monitored. An occurrence of a fault at one of the management points associated with the service path is identified based on the monitoring.

### BACKGROUND INFORMATION

Service providers are continually challenged to deliver value and convenience to consumers by providing compelling network services and advancing the underlying technologies. These network services may, for instance, be provided to customers through one or more service paths within a data network, e.g., an Ethernet-based network. Traditionally, however, network faults that occur at one or more intermediate points along a service path of an Ethernet-based network could not be determined without manually checking each of the intermediate points. Thus, traditional fault identification and resolution associated with Ethernet-based networks are slow and resource-intensive, as compared with other types of networks, resulting in substantial service downtime or degradation when network faults occur, as well as poor customer experience associated with Ethernet-based network services.

Therefore, there is a need for an approach to more effectively identify and resolve network faults of a service path within an Ethernet-based network.

### BRIEF DESCRIPTION OF THE DRAWINGS

Various embodiments are illustrated by way of example, and not by way of limitation, in the figures of the accompanying drawings in which like reference numerals refer to similar elements and in which:

FIG. 1A is a diagram of a system capable of providing fault isolation for a service path in an Ethernet-based network, according to an embodiment;

FIG. 1B is a diagram of a scenario utilizing automated fault isolation for a service path in an Ethernet-based network, according to an embodiment;

FIG. 2 is a diagram of a service fault manager, according to an embodiment;

FIG. 3 is a flowchart of a process for providing fault isolation for a service path in an Ethernet-based network, according to an embodiment;

FIG. 4 is a flowchart of a process for resolving issues related to a fault for one or more service paths, according to an embodiment;

FIG. 5 is a diagram illustrating a scenario of managing fault occurrences in a service path in an Ethernet-based network, according to an embodiment;

FIG. 6 is a diagram of a computer system that can be used to implement various embodiments; and

FIG. 7 is a diagram of a chip set that can be used to implement various embodiments.

### DESCRIPTION OF THE PREFERRED EMBODIMENT

An apparatus, method, and software for providing fault isolation for a service path in an Ethernet-based network are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described with respect to an Ethernet-based network, it is contemplated that these embodiments have applicability to other equivalent computer networking technologies.

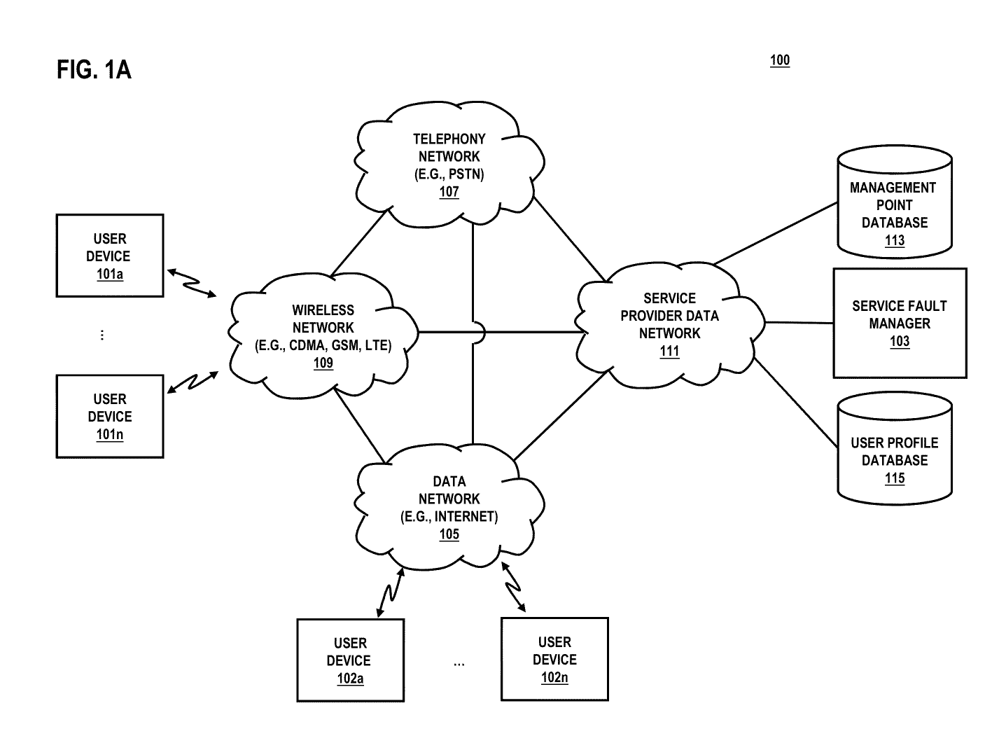

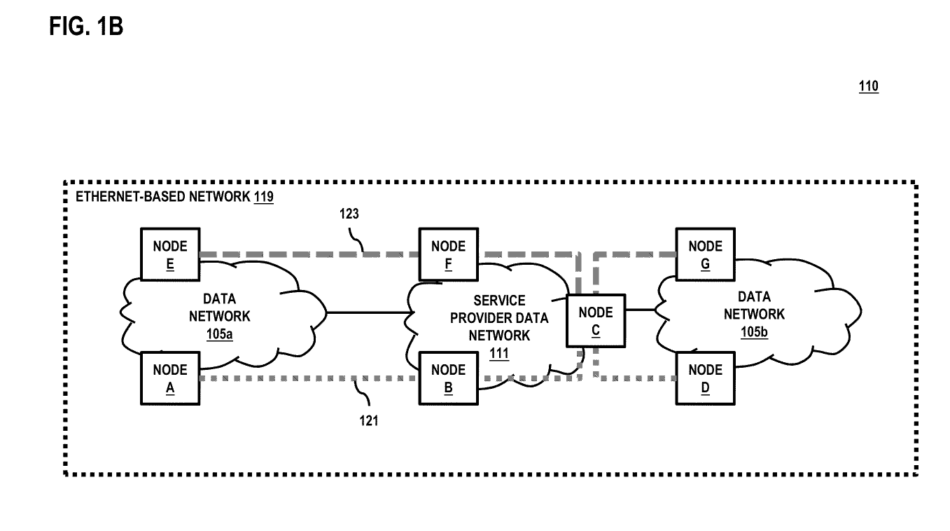

FIG. 1A is a diagram of a system capable of providing fault isolation for a service path in an Ethernet-based network, according to an embodiment. For the purpose of illustration, the system 100 may include one or more user devices (e.g., user devices 101a-101n, 102a-102n, etc.) that may be utilized to access services (e.g., having services paths that are monitored by a service fault manager 103) over one or more networks (e.g., data network 105, telephony network 107, wireless network 109, service provider data network 111, etc.). According to one embodiment, these services may be included as part of managed services supplied by a service provider (e.g., a wireless communication company) as a hosted or a subscription-based service made available to users of the user devices 101 and 102 through the service provider data network 111. As such, the service fault manager 103 may, for instance, be configured to facilitate automated identification and resolution of network faults that occur at one or more management points along service paths associated with these services. In this regard, service fault manager 103 may provide faster detection and resolution of network faults associated with one or more services, and, thus, improve customer experience associated with such services. As noted, the data services, in certain embodiments, conform with the Institute of Electrical and Electronics Engineers (IEEE) 802.3 standards.

As shown, the service fault manager 103 may be part of or connected to the service provider data network 111. In certain embodiments, the service fault manager 103 may include or have access to a management point database 113 and a user profile database 115. The management point database 113 may, for instance, be utilized to access or store current status information, service path data, history information, etc., associated with the management points of the service paths within one or more Ethernet-based networks. The user profile database 115 may be utilized to access or store user information, such as user identifiers, passwords, device information associated with users, user access data, etc. While specific reference will be made thereto, it is contemplated that the system 100 may embody many forms and include multiple and/or alternative components and facilities. In addition, although various embodiments are described with respect to Ethernet Service Operations, Administration, and Management (OAM) standards, it is contemplated that the approach described herein may be used with other operations, administration, and management standards or techniques.

As indicated, network faults that occur at one or more intermediate points along a service path of an Ethernet-based network are traditionally identified through manual queries of each of the intermediate points to determine all of the network fault occurrences. As such, traditional fault identification and resolution associated with Ethernet-based networks are slow and resource-intensive, as compared with other types of networks, resulting in substantial service downtime or degradation when network faults occur, as well as poor customer experience associated with Ethernet-based network services. As a result, standards such as Ethernet Services OAM have been introduced to facilitate network fault management of services, service paths, etc., of Ethernet-based network. For example, using Ethernet Services OAM, administrators are able to generally determine that a network fault has occurred at an end-to-end service. However, even with OAM-enhanced monitoring, typical fault monitoring systems may still require administrators to manually initiate and determine the particular location of a network fault, which continues to hinder efficient and effective resolution of issues associated with the network fault.

To address these issues, the system 100 of FIG. 1A provides the capability to facilitate automated identification and resolution of network faults that occur at one or more management points along service paths within an Ethernet-based network. By way of example, the service fault manager 103 may determine a service path that is within an Ethernet-based network and associated with a plurality of management levels, and monitor a plurality of management points (e.g., nodes, links, segments, etc.) that are along the service path and correspond to the management levels. Based on the monitoring of the management points, the service fault manager 103 may then automatically identify an occurrence of a fault at one of the management points associated with the service path regardless of different management levels at the management points. In certain embodiments, for instance, the management points may include an intermediate point and an end point, the intermediate point may correspond to one of the management levels, and the end point may correspond to another one of the management levels. In various embodiments, the one management point may include the intermediate point, and the one management level may be a lower level than the another one management level. In this way, through monitoring of Ethernet-based networks and service paths within Ethernet-based networks having different management levels (e.g., OAM management levels), the service fault manager 103 can determine the root cause of a network fault (e.g., loss of service, degradation of service, etc.) through analysis of monitoring information such as data provided by OAM maintenance entity end points (MEPs) and maintenance entity intermediate points (MIPs).

In another embodiment, the service fault manager 103 may initiate generation of one or more service messages for transmission to the management points according to a predetermined schedule, a verification process, or a combination thereof, and the monitoring of the management points, the identification of the fault occurrence at the one management point, or a combination thereof may be based on the service messages. By way of example, the service fault manager 103 may cause generation and transmission of continuity check messages (CCMs) on a periodic basis to each of the management points (e.g., from other management points), for instance, as a way of detecting loss of continuity or incorrect network connections. In one use case, when a CCM destined for a particular management point becomes lost or delayed for a predetermined period of time, such a situation may signal that a network fault has occurred (e.g., the predetermined time may be based on previous performance parameters associated with the management points). Accordingly, in response, the service fault manager 103 may automatically cause the management points to send loopback messages to verify connectivity with other management points to determine where there is a break in connectivity.

In another embodiment, the service fault manager 103 may identify one or more other service paths affected by the fault based on a determination that the other service paths include the one management point. In one use case, for instance, a particular management point may be identified as the starting location of a fault occurrence that has occurred along a first service path associated with a first service. To avoid the prolong effects of the network fault upon the network as a whole, the service fault manager 103 may identity other service paths (e.g., of other services) that include the particular management point in response to the identification of that management point as the starting location of the fault occurrence. In this way, the service fault manager 103 may thereafter initiate one or more actions to resolve issues of the other service paths (along with issues of the first service path) that are related to the fault occurrence. In another scenario, the service fault manager 103 may utilize automated fault isolation (e.g., to a particular management point, a group of management points, etc.) to detect a fault on an individual service and then determine whether that fault was caused by a lower level fault. If, for instance, a lower level fault has occurred at an intermediate link, the service fault manager 103 may determine all other services that ride on the affected link to mitigate the effects of the lower level fault.

In another embodiment, the service fault manager 103 may initiate switching of the service path, the other service paths, or a combination thereof with one or more predetermined backup paths. For example, as shown in FIG. 1B, an Ethernet-based network 119 may include data networks 105a and 105b along with service provider data network 111. The Ethernet-based network 119 may, for instance, include a first service path 121 with nodes A, B, C, and D, and a second service path 123 with nodes E, F, C, and G, where nodes A, D, E, and G correspond to management level 4 (e.g., one particular management level of the data networks 105a and 105b), and nodes B, C, and F correspond to management level 1 (e.g., one particular management level of the service provider data network 111). Upon detecting that a network fault associated with the first service path 121 has occurred, the service fault manager 103 may automatically determine whether a network fault has occurred at a lower level node. If, for instance, a network fault is determined to have occurred at lower level node C, the service fault manager 103 may therefore identity one or more backup service paths to replace the first and second service paths 121 and 123 for their associated services since both service paths 121 and 123 as well as their associated services may be negatively affected by that lower level node. As such, even though the network fault was initially detected for the service path 121, the service fault manager 103 may automatically resolved fault-related issues for the service path 123 based on a determination that the service path 123 also included the affected lower level node C. Moreover, in some embodiments, the service fault manager 103 may determine the most efficient or optimal backup path of the one or more backup paths for each of the first and second service paths 121 and 123, and replace each of the first and second service paths 121 and 123 with its respective efficient/optimal backup path. In other embodiments, the service fault manager may also generate back-up paths in real-time to provide switching, for instance, when no predetermined backup path is available for a particular service. Thus, in this way, negative effects upon network users of the associated services may be mitigated.

In another embodiment, the service fault manager 103 may initiate generation of one or more alarms to initiate troubleshooting for the service path, the other service paths, or a combination thereof in response to the identification of the fault occurrence at the one management point. In one scenario, for instance, service providers or operators may receive a notification with respect to the fault occurrence with information that will enable them to begin troubleshooting. Additionally, or alternatively, the alarms may trigger automated switching of an affected service path to backup service paths to mitigate the negative effects of the fault occurrence until issues with the affected service path are resolved. Moreover, in some embodiment, these alarm may include messages to users also be sent to users of the service path to notify them of the fault and the actions that are being taken to resolve the fault.

It is noted that the user devices 101 and 102, the service fault manager 103, and other elements of the system 100 may be configured to communicate via the service provider data network 111. According to certain embodiments, one or more networks, such as the data network 105, the telephony network 107, and/or the wireless network 109, may interact with the service provider data network 111. The networks 105-111 may be any suitable wireline and/or wireless network, and be managed by one or more service providers. For example, the data network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network. The telephony network 107 may include a circuit-switched network, such as the public switched telephone network (PSTN), an integrated services digital network (ISDN), a private branch exchange (PBX), or other like network. Meanwhile, the wireless network 109 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

Although depicted as separate entities, the networks 105-111 may be completely or partially contained within one another, or may embody one or more of the aforementioned infrastructures. For instance, the service provider data network 111 may embody circuit-switched and/or packet-switched networks that include facilities to provide for transport of circuit-switched and/or packet-based communications. It is further contemplated that the networks 105-111 may include components and facilities to provide for signaling and/or bearer communications between the various components or facilities of the system 100. In this manner, the networks 105-111 may embody or include portions of a signaling system 7 (SS7) network, Internet protocol multimedia subsystem (IMS), or other suitable infrastructure to support control and signaling functions.

Further, it is noted that the user devices 101 and 102 may be any type of mobile or computing terminal including a mobile handset, mobile station, mobile unit, multimedia computer, multimedia tablet, communicator, netbook, Personal Digital Assistants (PDAs), smartphone, media receiver, personal computer, workstation computer, set-top box (STB), digital video recorder (DVR), television, automobile, appliance, etc. It is also contemplated that the user devices 101 and 102 may support any type of interface for supporting the presentment or exchange of data. In addition, user devices 101 and 102 may facilitate various input means for receiving and generating information, including touch screen capability, keyboard and keypad data entry, voice-based input mechanisms, accelerometer (e.g., shaking the user device 101 or 102), and the like. Any known and future implementations of user devices 101 and 102 are applicable. It is noted that, in certain embodiments, the user devices 101 and 102 may be configured to establish peer-to-peer communication sessions with each other using a variety of technologies—i.e., near field communication (NFC), Bluetooth, infrared, etc. Also, connectivity may be provided via a wireless local area network (LAN). By way of example, a group of user devices 101 and 102 may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 101 or 102, i.e., IP addresses that are accessible to devices connected to the service provider data network 111 as facilitated via a router.

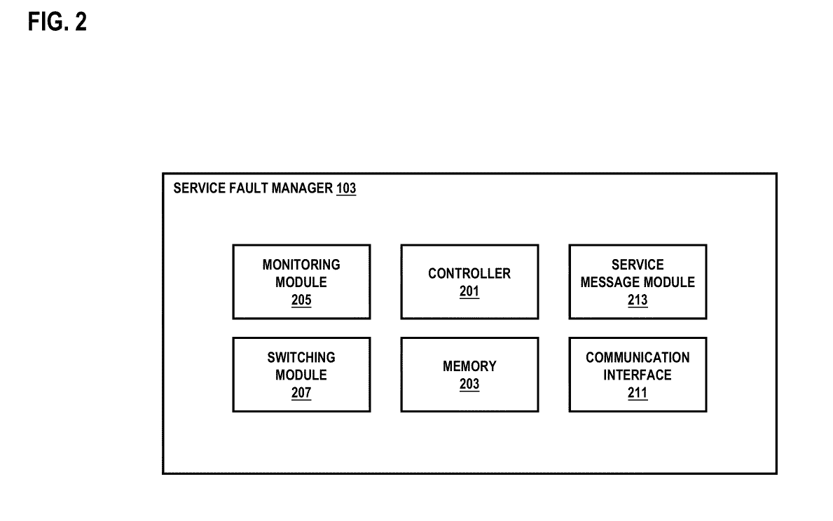

FIG. 2 is a diagram of the components of a service fault manager capable of Ethernet-based network fault isolation, according to an embodiment. By way of example, the service fault manager 103 includes one or more components for providing fault isolation for a service path in an Ethernet-based network. It is contemplated that the functions of these components may be combined in one or more components or performed by other components of equivalent functionality. In this embodiment, service fault manager 103 includes controller 201, memory 203, a monitoring module 205, a service message module 207, a switching module 209, and a communication module 211.

The controller 201 may execute at least one algorithm (e.g., stored at the memory 203) for executing functions of the service fault manager 103. For example, the controller 201 may interact with the monitoring module 205 to determine a service path that is within an Ethernet-based network and associated with a plurality of management levels. The service path may, for instance, include a plurality of management points (e.g., service path 121 of FIG. 1B includes nodes A, B, C, and D that may correspond to a variety of management levels) which data of a service associated with the service path travel through to provide service continuity to end-users. The monitoring module 205 may also monitor these management points, and identify an occurrence of a fault at one of the management point associated with the service path based on such monitoring.

In various embodiments, for instance, the monitoring module 205 may work with the service message module 207 to initiate generation of one or more service messages for transmission to the management points according to a predetermined schedule and/or a verification process. As an example, CCMs may be generated and transmitted on a periodic basis to each of the management points (e.g., from other management points) as a way of detecting loss of continuity or incorrect network connections.

In certain embodiments, the service message module 207 may also generate one or more alarms to initiate troubleshooting for the service path (or other service paths) in response to the identification of the fault occurrence at the one management point. In one use case, for instance, the service message module 207 may send an alarm upon the identification of the fault occurrence at a particular management point to trigger the switching module 209 to switch affected services from the service path (or other service paths) to one or more backup service paths. In this way, as discussed, negative effects upon network users of the affected services may be mitigated.

In addition, the controller 201 may utilize the communication interface 201 to communicate with other components of the service fault manager 103, the user devices 101 and 102, and other components of the system 100. For example, the controller 201 may direct the communication interface 201 to receive and transmit updates to the management point database 113, to transmit notifications to users with respect to network fault isolation and resolution, to trigger switching from an initial service path to a backup service path, etc. Further, the communication interface 211 may include multiple means of communication. For example, the communication interface 211 may be able to communicate over short message service (SMS), multimedia messaging service (MMS), internet protocol, instant messaging, voice sessions (e.g., via a phone network), email, or other types of communication.

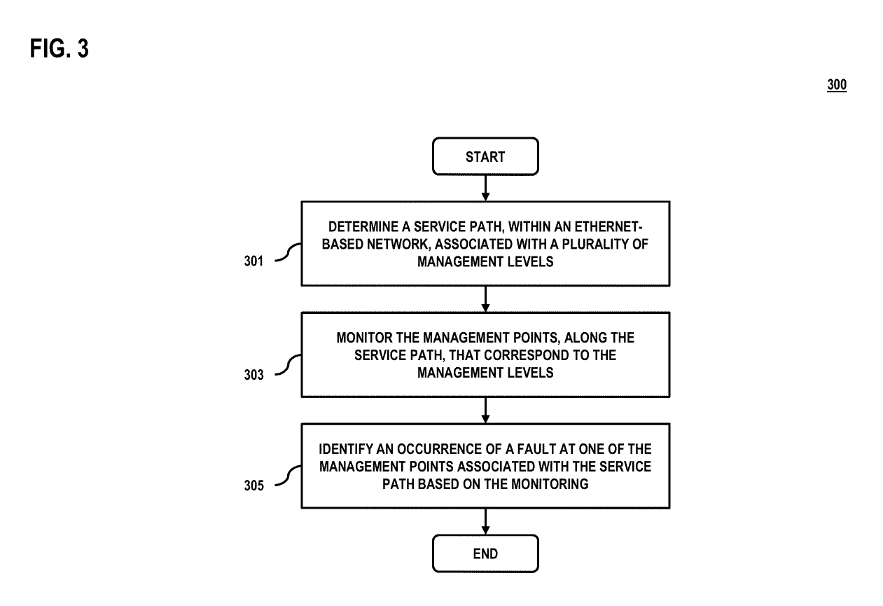

FIG. 3 is a flowchart of a process for providing fault isolation for a service path in an Ethernet-based network, according to an embodiment. For the purpose of illustration, process 300 is described with respect to FIGS. 1A and 1B. It is noted that the steps of the process 300 may be performed in any suitable order, as well as combined or separated in any suitable manner. In step 301, the service fault manager 103 may determine a service path that is within an Ethernet-based network and associated with a plurality of management levels. The service path may, for instance, include a plurality of management points which data of a service associated with the service path travel through to provide service continuity to end-users.

In step 303, the service fault manager 103 may monitor a plurality of management points, along the service path, that correspond to the management levels. As indicated, the management points may include nodes, links, or segments, along the service path, and these nodes, links, or segments may correspond to different management levels. In certain embodiments, for instance, the management points may include an intermediate point and an end point, the intermediate point may correspond to one of the management levels, and the end point may correspond to another one of the management levels. In various embodiments, the one management point may include the intermediate point, and the one management level may be a lower level than the another one management level.

In step 305, the service fault manager 103 may identify an occurrence of a fault at one of the management points associated with the service path based on the monitoring. By way of example, the service fault manager 103 may cause generation and transmission of CCMs on a periodic basis to each of the management points (e.g., from other management points) to detect loss of continuity or incorrect network connections. For instance, when a CCM destined for a particular management point becomes lost or delayed for a predetermined period of time, such a situation may signal that a network fault has occurred. Accordingly, in response, the service fault manager 103 may automatically cause the management points to send loopback messages to verify connectivity with other management points to determine where there is a break in connectivity. In this way, through monitoring of Ethernet-based networks and service paths within Ethernet-based networks having different management levels (e.g., OAM management levels), the service fault manager 103 can determine the root cause of a network fault (e.g., loss of service, degradation of service, etc.) through analysis of monitoring information such as data provided by OAM MEPs and MIPs.

In addition, faults may further be determined through statistical analysis based on previous and/or current performance parameters. Performance parameters may, for instance, include frame loss ratio, frame delay, frame delay variation, etc. In one scenario, frame loss ratio may be determined by the ratio of number of service frames not delivered to total number of service frames during a certain time interval. Frame delay may be determined by the round trip delay for a frame where the time elapsed since start of transmission is found. Frame delay variation may be determined by taking transmit time stamps and receive time stamps in calculating the delay.

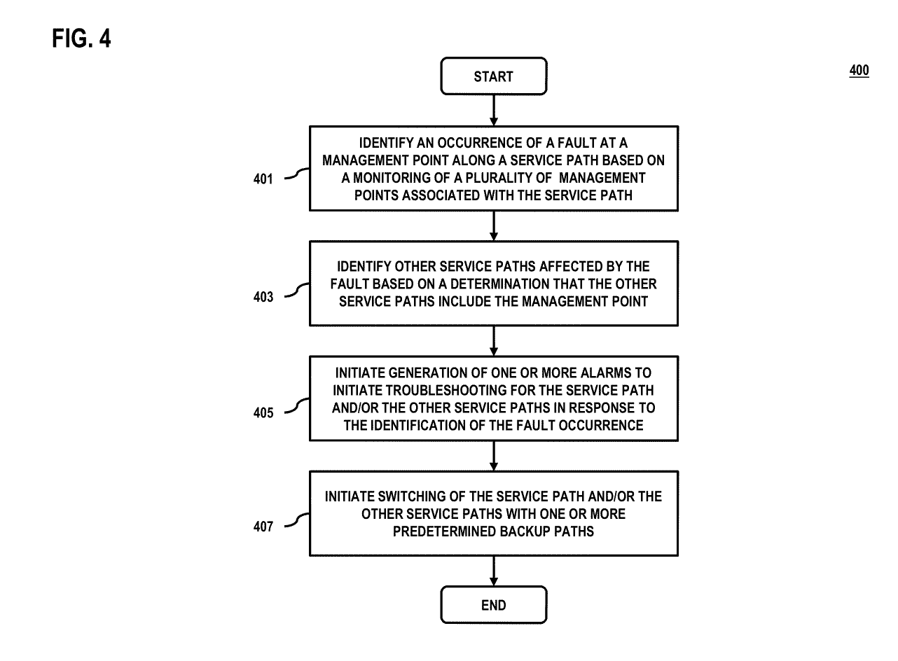

FIG. 4 is a flowchart of a process for resolving issues related to a fault for one or more service paths, according to an embodiment. For the purpose of illustration, process 400 is described with respect to FIGS. 1A and 1B. It is noted that the steps of the process 400 may be performed in any suitable order, as well as combined or separated in any suitable manner. In step 401, the service fault manager 103 may identify an occurrence of a fault at a management point of a plurality of management points associated with a service path based on a monitoring of the management points.

In step 403, the service fault manager 103 may identify other service paths affected by the fault based on a determination that the other service paths include the management point (at which the fault occurred). In one use case, for instance, a particular management point may be identified as the root cause of a network fault (e.g., where the network fault started) associated with a first service. To avoid the prolong effects of the network fault upon the network as a whole, the service fault manager 103 may identity other service paths (e.g., of other services) that include the particular management point in response to the identification of that management point as the root cause of the network fault. In this way, the service fault manager 103 may thereafter initiate one or more actions to resolve issues of the other service paths that are related to the fault occurrence.

For example, in step 405, the service fault manager 103 may initiate generation of one or more alarms to initiate troubleshooting for the service path and/or the other service paths in response to the identification of the fault occurrence. These alarms may then trigger step 407, where the service fault manager 103 initiates switching of the service path and/or the other service paths with one or more predetermined backup paths. For example, as discussed, FIG. 1B illustrates an Ethernet-based network 119 that includes data networks 105a and 105b along with service provider data network 111. In addition, the Ethernet-based network 119 may include a first service path 121 that utilizes nodes A, B, C, and D, and a second service path 123 that utilizes nodes E, F, C, and G, where nodes A, D, E, and G correspond to management level 4 (e.g., one particular management level of the data networks 105a and 105b), and nodes B, C, and F correspond to management level 1 (e.g., one particular management level of the service provider data network 111). If, for instance, a network fault is determined to have occurred at lower level node C, the alarms of step 405 may be generated to trigger the service fault manager 103 to identity one or more backup service paths that will replace the first and second service paths 121 and 123 for their associated services since both service paths 121 and 123 along with their associated services may be negatively affected by that lower level node.

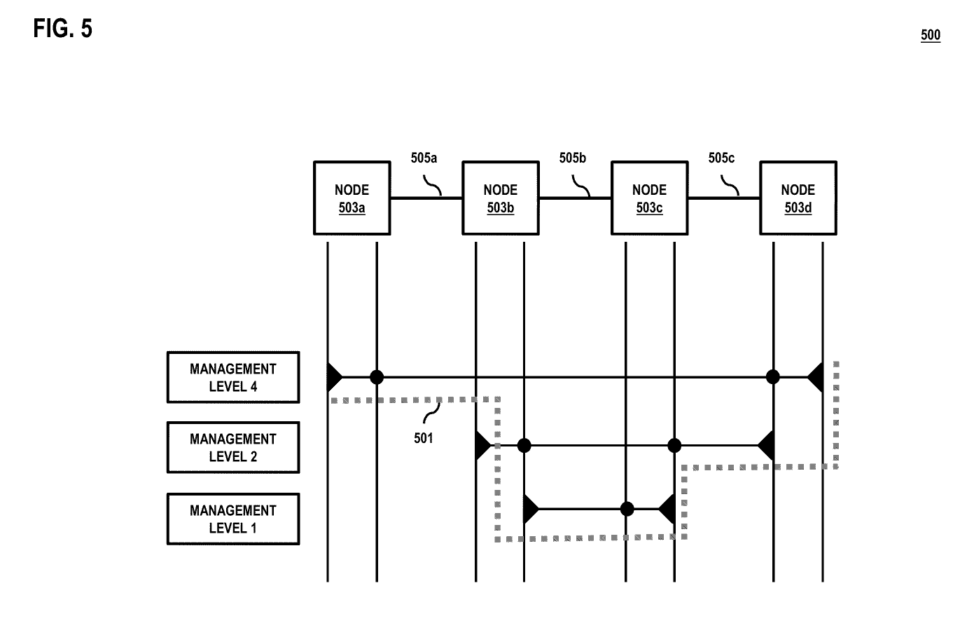

FIG. 5 is a diagram illustrating a scenario of managing fault occurrences in a service path in an Ethernet-based network, according to an embodiment. As shown, in FIG. 5, a service path indicator 501 may include a number of management points (e.g., various ends of nodes 503a-503d, segments 505a-505c, etc.), and those managements points may be located at different management levels (e.g., management level 4, management level 2, management level 1, etc.). The management levels 1-4 may, for instance, include a customer level, an operator level, a provider level, or other management levels. As discussed, the service fault manager 103 may monitor a service path of an Ethernet-based network using a number of techniques, such as through the generation of service messages by various MEPs (black triangles) and MIPs (black circles), to detect network faults associated with the service path 501, to verify and determine the root cause of network faults upon detection, etc. When the MEPs (e.g., which may be sending CCMs on a periodic basis) detect a network fault (e.g., due to CCM failure or degradation), the MEPs may use the MEPs and MIPs of the different management levels in order to separate service segments 505a-505c to determine the root cause of network faults upon detection.

In addition, in certain embodiments, such information may be utilized to mitigate the effects of a lower level fault. For example, if the right end of node 503b (or the left end of segment 505b) is determined to be the root cause of a fault associated with the service path 501, the service fault manager 103 may identity other service paths (not shown for illustrative convenience) that include the right end of node 503b (or the left end of segment 505b) so that issues related to the fault at the other service paths may be quickly resolved (e.g., through switching of the services paths with alternative backup service paths).

The processes described herein for providing fault isolation for a service path in an Ethernet-based network may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

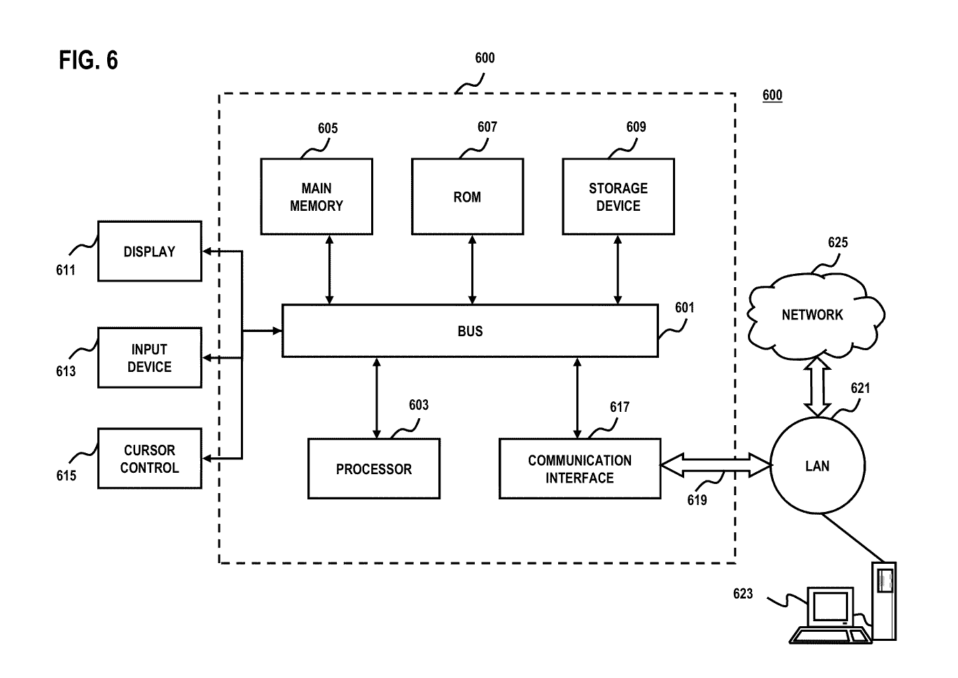

FIG. 6 illustrates computing hardware (e.g., computer system) upon which an embodiment of the invention can be implemented. The computer system 600 includes a bus 601 or other communication mechanism for communicating information and a processor 603 coupled to the bus 601 for processing information. The computer system 600 also includes main memory 605, such as random access memory (RAM) or other dynamic storage device, coupled to the bus 601 for storing information and instructions to be executed by the processor 603. Main memory 605 also can be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to an embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. Thus, embodiments of the invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the invention through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

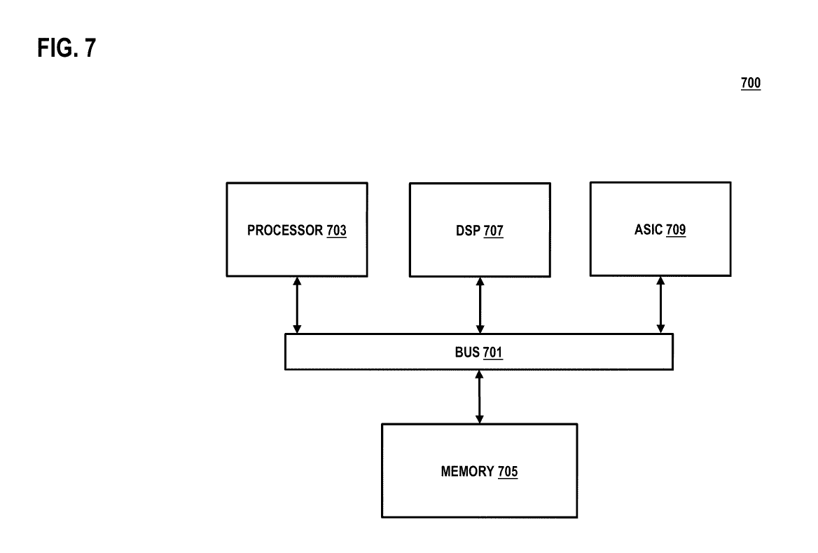

FIG. 7 illustrates a chip set 700 upon which an embodiment of the invention may be implemented. Chip set 700 is programmed to provide fault isolation for a service path in an Ethernet-based network as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of providing fault isolation for a service path in an Ethernet-based network.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide fault isolation for a service path in an Ethernet-based network. The memory 705 also stores the data associated with or generated by the execution of the inventive steps.

While certain embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
determining a service path within an Ethernet-based network and associated with a plurality of management levels;
monitoring a plurality of management points, along the service path, that correspond to the management levels; and
identifying an occurrence of a fault at one of the management points associated with the service path based on the monitoring.

2. A method according to claim 1, wherein the management points include an intermediate point and an end point, the intermediate point corresponds to one of the management levels, and the end point corresponds to another one of the management levels.

3. A method according to claim 2, wherein the one management point include the intermediate point, and the one management level is a lower level than the another one management level.

4. A method according to claim 1, further comprising:
initiating generation of one or more service messages for transmission to the management points according to a predetermined schedule, a verification process, or a combination thereof,
wherein the monitoring of the management points, the identification of the fault occurrence at the one management point, or a combination thereof are based on the service messages.

5. A method according to claim 1, further comprising:
identifying one or more other service paths affected by the fault based on a determination that the other service paths include the one management point.

6. A method according to claim 5, further comprising:
initiating switching of the service path, the other service paths, or a combination thereof with one or more predetermined backup paths.

7. A method according to claim 5, further comprising:
initiating generation of one or more alarms to initiate troubleshooting for the service path, the other service paths, or a combination thereof in response to the identification of the fault occurrence at the one management point.

8. A method according to claim 1, wherein the fault includes a loss of service, a degradation of service, or a combination thereof.

9. An apparatus comprising:
a processor; and
a memory including computer program code for one or more programs,
the memory and the computer program code configured to, with the processor, cause the apparatus to perform at least the following,
determine a service path within an Ethernet-based network and associated with a plurality of management levels;
monitor a plurality of management points, along the service path, that correspond to the management levels; and
identify an occurrence of a fault at one of the management points associated with the service path based on the monitoring.

10. An apparatus according to claim 9, wherein the management points include an intermediate point and an end point, the intermediate point corresponds to one of the management levels, and the end point corresponds to another one of the management levels.

11. An apparatus according to claim 10, wherein the one management point include the intermediate point, and the one management level is a lower level than the another one management level.

12. An apparatus according to claim 9, wherein the apparatus is further caused to:
initiate generation of one or more service messages for transmission to the management points according to a predetermined schedule, a verification process, or a combination thereof,
wherein the monitoring of the management points, the identification of the fault occurrence at the one management point, or a combination thereof are based on the service messages.

13. An apparatus according to claim 9, wherein the apparatus is further caused to:
identify one or more other service paths affected by the fault based on a determination that the other service paths include the one management point.

14. An apparatus according to claim 13, wherein the apparatus is further caused to:
initiate switching of the service path, the other service paths, or a combination thereof with one or more predetermined backup paths.

15. An apparatus according to claim 13, wherein the apparatus is further caused to:
initiate generation of one or more alarms to initiate troubleshooting for the service path, the other service paths, or a combination thereof in response to the identification of the fault occurrence at the one management point.

16. An apparatus according to claim 9, wherein the fault includes a loss of service, a degradation of service, or a combination thereof.

17. A system comprising:
one or more processors configured to execute a service fault manager,
wherein the service fault manager is configured to determine a service path within an Ethernet-based network and associated with a plurality of management levels, to monitor a plurality of management points, along the service path, that correspond to the management levels, and to identify an occurrence of a fault at one of the management points associated with the service path based on the monitoring.

18. A system according to claim 17, wherein the management points include an intermediate point and an end point, the intermediate point corresponds to one of the management levels, and the end point corresponds to another one of the management levels.

19. A system according to claim 17, wherein the service fault manager is further configured to:
initiate generation of one or more service messages for transmission to the management points according to a predetermined schedule, a verification process, or a combination thereof,
wherein the monitoring of the management points, the identification of the fault occurrence at the one management point, or a combination thereof are based on the service messages.

20. A system according to claim 17, wherein the service fault manager is further configured to:
identify one or more other service paths affected by the fault based on a determination that the other service paths include the one management point; and
initiate generation of one or more alarms to initiate troubleshooting for the service path, the other service paths, or a combination thereof in response to the identification of the fault occurrence at the one management point.
